(19) United States
(12) Patent Application Publication
(10) Pub. No.: US 2007/0219473 A1
(43) Pub. Date: Sep. 20, 2007

(54) Non-invastive apparatus and method for dynamic motion therapy in a weightless environment

(76) Inventors: Roger J. Talish, Hillsborough, NJ (US); Clinton T. Rubin, Port Jefferson, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/715,222

(22) Filed: Mar. 7, 2007

Related U.S. Application Data
(60) Provisional application No. 60/779,926, filed on Mar. 7, 2006.

(51) Int. Cl. A61H 1/00

(52) U.S. Cl. 601/46

(57) ABSTRACT

A non-invasive apparatus for dynamic motion therapy in a weightless environment include a vibration table having a non-rigidly supported platform for generating resonant vibration and for externally transferring vibrations to the musculoskeletal system, and ankle belts or other securing means to secure a person to the vibration table. The method of providing dynamic motion therapy to a person in a weightless environment includes the steps of (a) providing a vibration table having a non-rigidly supported platform; (b) securing the person to the non-rigidly supported platform; (c) subjecting the person to resonant vibrations generated by the non-rigidly supported platform; and (d) repeating steps (b) and (c) during a predetermined treatment duration. The predetermined treatment duration is at least the duration of the weightless environment.

### PRIORITY

This patent application claims priority to a provisional application filed on Mar. 7, 2006 and assigned U.S. Provisional Application Ser. No. 60/779,926; the entire contents of which are incorporated herein by reference.

### BACKGROUND

1. Technical Field

The present disclosure relates generally to dynamic motion therapy. In particular, the present disclosure relates to a non-invasive apparatus and method for dynamic motion therapy in a weightless environment.

2. Description of the Related Art

A method of using resonant vibrations for treating postural instability is described in U.S. Pat. No. 6,607,497 B2. The method includes the steps of (a) providing a vibration table having a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 B2 entails the patient standing on the vibration table or unstable standing platform which includes at least one accelerometer mounted to the outboard side thereof. The patient is then exposed to a vibrational stimulus by the unstable standing platform. The unstable standing platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day (24-hour period) in an effort to improve the postural stability of the patient.

An aspect of the present disclosure is to provide an apparatus and method for enabling vibrational treatment in a weightless environment. It has been observed that a weightless environment, such as interplanetary space, can subject a person to debilitating, injurious, and possibly muscoloskeletal stresses, including postural and gait instability. Accordingly, a need exists for enabling a person in a weightless environment to be vibrationally treated using the method disclosed in U.S. Pat. No. 6,607,497 B2, the contents of which are incorporated herein by reference.

### SUMMARY

A non-invasive apparatus and method for dynamic motion therapy are herein described for providing vibrational treatment of the musculoskeletal system in a weightless environment using resonant vibrations or a vibrational stimulus produced by a vibration table similar to the vibration table described in U.S. Pat. No. 6,607,497 B2.

The apparatus and method of the present disclosure may be used during spaceflight or while at an interplanetary body to minimize postural and gait instabilities due to a weightless environment. The resonant vibrations or vibrational stimulus produced by a vibration table of the apparatus of the present disclosure causes the musculoskeletal system to maintain its mass and density. The apparatus of the present disclosure includes a vibration table having a non-rigidly supported platform for generating resonant vibrations; and means for securing a person to the non-rigidly supported platform.

The vibration table preferably vibrates to produce resonant vibrations having a frequency in the range of 1 Hz to 100 KHz, and preferably from 1 Hz to 10 KHz. The resonant vibrations provide a vibrational stimulus to the person secured to the non-rigidly supported platform. The vibrational stimulus reduces the adverse effects caused to the musculoskeletal system by the weightless environment.

The method of providing dynamic motion therapy to a person in a weightless environment in accordance with the present disclosure includes the steps of (a) providing a vibration table having a non-rigidly supported platform; (b) securing the person to the non-rigidly supported platform; (c) subjecting the person to resonant vibrations generated by the non-rigidly supported platform; and (d) repeating steps (b) and (c) during a predetermined treatment duration. The predetermined treatment duration is at least the duration of the weightless environment.

Other features and advantages of the present disclosure will become apparent from the following detailed description, taken in conjunction with the accompanying drawings, which illustrate, by way of example, the principals of the invention.

### BRIEF DESCRIPTION OF THE DRAWINGS

Preferred embodiments of the present disclosure are described hereinbelow with reference to the drawings wherein:

FIG. 1 is an isometric view of an apparatus having a non-rigidly supported platform with a person undergoing dynamic motion therapy in accordance with the principles of the present disclosure;

FIG. 2 is an isometric view of an alternative embodiment of an apparatus according to the present disclosure;

FIG. 3 is an isometric view of another embodiment of an apparatus according to the present disclosure; and

FIG. 4 is a flow diagram illustrating the steps for performing dynamic motion therapy in a weightless environment in accordance with the present disclosure.

### DETAILED DESCRIPTION

The apparatus and method of the present disclosure are generally used in a weightless environment, such as in interplanetary space. In interplanetary space, the flight crew is typically subjected to musculoskeletal changes. The apparatus and method of the present disclosure may be employed to enable vibrational treatment or dynamic motion therapy following an evaluation of the musculoskeletal system. Such an evaluation may be conducted using the method and system described in U.S. Pat. No. 6,561,991 B2 granted to McLeod et al., entitled “Non-invasive method and system of quantifying human postural stability,” the contents of which are incorporated by reference, and/or U.S. Pat. No. 6,234,975 granted to McLeod et al., entitled “Non-invasive method of physiologic vibration quantification,” the contents of which are incorporated herein by reference.

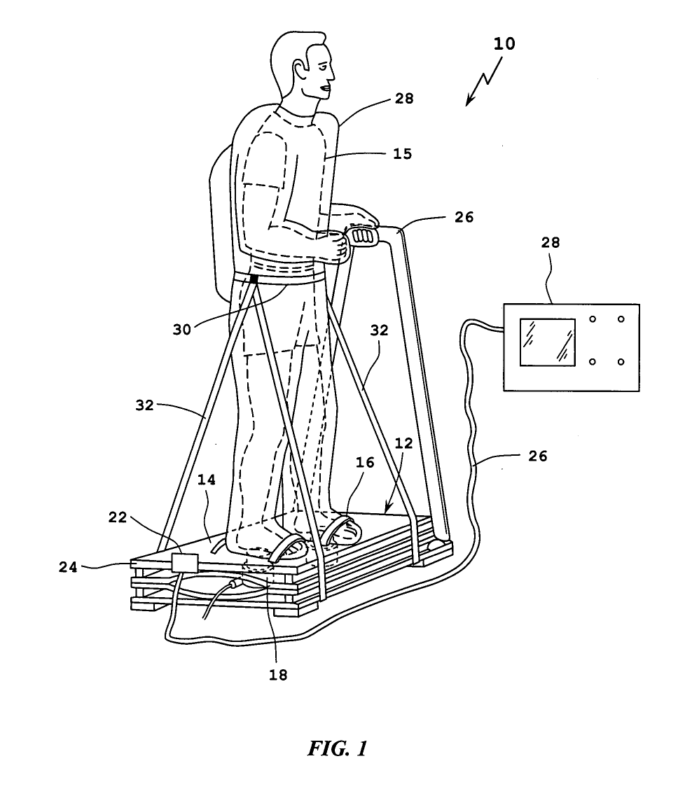

Referring initially to FIG. 1, there is illustrated a non-invasive apparatus for dynamic motion therapy in a weightless environment in accordance with the principles of the present disclosure. The apparatus is designated generally by reference number 10. Apparatus 10 includes vibration table 12 having a non-rigidly supported platform 14 and configured to vibrate and subject the musculoskeletal system of a person 15 to a vibrational stimulus. Ankle belts or straps 16 or other type of securing devices secure the person to platform 14. Other securing devices may be used including, for example, boot or shoe-type securing mechanisms, waist straps, shoulder straps, leg straps, and/or combinations thereof to maintain the person's feet in contact with platform 14 during vibrational treatment in the weightless environment.

The person must also be forcibly secured to platform 14 in the weightless environment, since there is no gravity for “loading” platform 14. As such, additional straps or securing mechanisms are needed for applying a downward force to forcibly secure the person to platform 14. In the embodiment, for example, as shown by FIG. 1, a belt 30 is provided around the person's space suit 28. Straps 32, such as elastic bungee cords, are connected to belt 30 which tightly extend around the bottom of table 12 and back to belt 30, thereby applying a downward force to the person (simulating gravity) to load platform 14.

Other devices for securing a person 15 to platform 14 and loading platform 14 include a chair or stool attached to platform 14 wherein said chair or stool includes a seatbelt for securing the person thereto and straps for tethering the chair or stool to platform 14. Alternatively, a stationary bike may be attached to platform 14, wherein said stationary bike may include a backrest and a belt or strap to secure the person thereto and straps for tethering the stationary bike to platform 14. In yet another embodiment, a bench or couch having at least one strap or belt for securing the person thereto and tethering the bench or couch to platform 14, may be attached to platform 14. The apparatus 10 further includes a handrail 26 for providing the person 14 with upright support.

It is contemplated that the vibrations generated by vibration table 12 are generated by electrical means 18 located underneath platform 14 and attached thereto. Alternatively, mechanical and other means may be employed for vibrating the non-rigidly supported platform 14. At least one accelerometer 22 may be used to measure the vibrational response of the person as shown in FIG. 1. Accelerometer 22 is mounted to vibration table 12 on outboard side 24. Accelerometer 22 is used to measure the vibrational response of the person to simultaneously determine postural stability of the person, if so desired, using the method described in U.S. Pat. No. 6,607,497 B2, while providing vibrational treatment to the person in a weightless environment, in accordance with the present disclosure.

As described in U.S. Pat. No. 6,607,497 B2, the vibrational response is measured and recorded by a spectrum analyzer/computer 28 which is electrically connected to the accelerometer 22 by a cable 26. The accelerometer response data is analyzed to extract information on postural sway. Preferably, the accelerometer 22 records the person's natural sway pattern.

The frequencies of the resonant vibrations generated by the vibration table 12 are in the range of 1 Hz to 100 KHz, and preferably from 1 Hz to 10 KHz. The vibrational waves of the resonant vibrations are preferably sinusoidal; however, other waveforms are contemplated. Vibrational treatment is preferably performed at a predetermined frequency for a predetermined period of time during a predetermined treatment duration. The predetermined period of time and the predetermined treatment duration can depend on one or more patient-specific parameters. These parameters include specific factors relating to the individual person such as, for example, age, sex, weight, postural stability, etc, as well as any abnormalities relating to the person and/or any environmental conditions deemed relevant. For example, the predetermined frequency can be 30 Hz, the predetermined period of time can be ten minutes during a 24-hour period, and the predetermined treatment duration can be at least the duration of the weightless environment.

To maintain the active design and cost estimate of the spaceflight mission, it is preferred that apparatus 10 be fabricated from a lightweight material, such as, for example, and not limited to, aluminum, fiberglass, high strength synthetic fibers, and any other lightweight material.

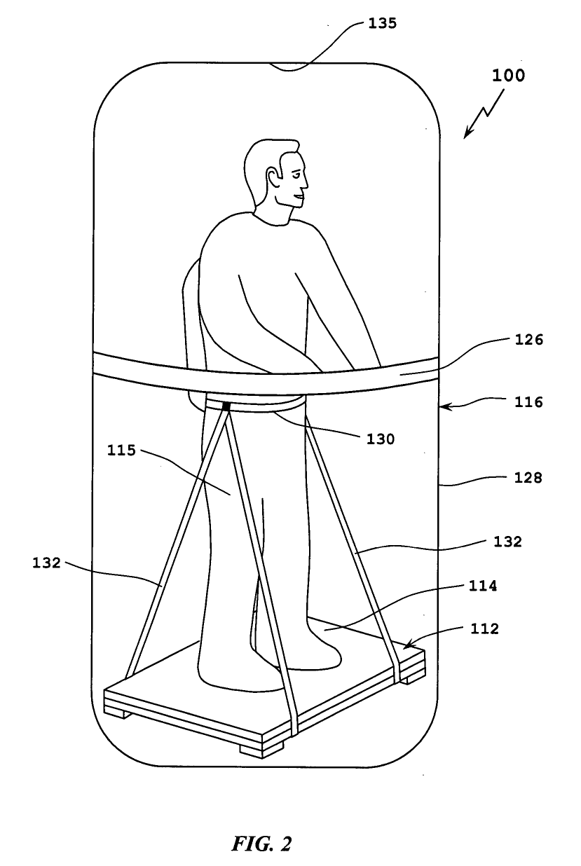

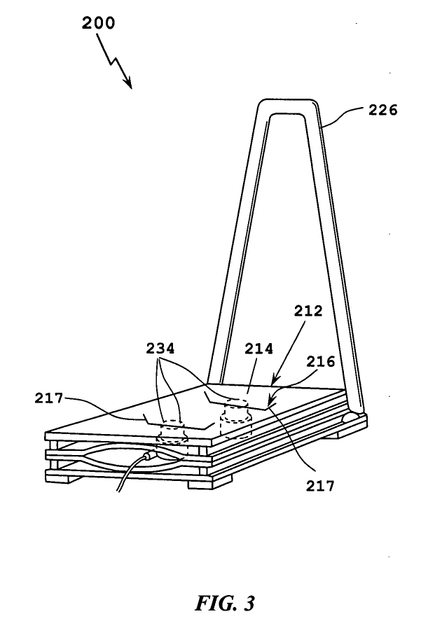

FIGS. 2-3 show alternative embodiments for maintaining the person on platform 14 during vibrational treatment in a weightless environment. Apparatus 100 and 200 are similar to apparatus 10 and will only be discussed in detail to the extent necessary to identify differences in construction and/or operation.

With reference to FIG. 2, apparatus 100 includes vibration table 112 having a non-rigidly supported platform 114 configured to vibrate and subject the musculoskeletal system of a person 115 to a vibrational stimulus. Chamber 116 or other securing devices secures the person to platform 114, as well as “loads” platform 14. In the embodiment, for example, as shown by FIG. 2, a belt 130 is provided around the person's space suit 129. Straps 132, such as elastic bungee cords, are connected to belt 130 which tightly extend around the bottom of table 112 and back to belt 130, thereby applying a downward force to the person (simulating gravity) to load platform 114 in a weightless environment. Alternatively, other support or securing devices may be used including, for example, waist straps, shoulder straps, leg straps, and/or combination thereof.

Chamber 116 includes a rectangular or cylindrical enclosure 128 and handrail 126 for providing upright support to person 115. Alternatively, enclosure 28 may be constructed to custom fit a person such that the person does not have much head room and is forced against platform 114 by the top wall 135 of chamber 116. In such an embodiment, there is no need for straps or other securing means. Chamber 116 may also include closing doors for enclosing person 115 therein. In operation, the person 115 enters or steps the chamber, the person 115 holds handrails 126 and the person is subjected to a vibrational stimulus in accordance with the principles of the present disclosure.

With reference to FIG. 3, apparatus 200 includes vibration table 212 having a non-rigidly supported platform 214 configured to vibrate and subject the musculoskeletal system of a person to a vibrational stimulus. Binding mechanism 216, having rails 217 and slots 234, secures the person to platform 214. Binding mechanism 216 secures the person to platform 214 by anchoring the person's boot to platform 214 in a locking manner similar to how a ski boot is binded to a ski as shown and described in U.S. Pat. No. 5,803,480, the contents of which are incorporated herein by reference.

The person must also be forcibly secured to platform 214 in the weightless environment, since there is no gravity for “loading” platform 214. As such, additional straps or securing mechanisms are needed for applying a downward force to forcibly secure the person to platform 214. In the embodiment, for example, as shown by FIG. 3, a belt (not shown) is provided around the person's space suit as similarly described above for the embodiment shown by FIG. 1. Straps (not shown), such as elastic bungee cords, are connected to belt as similarly shown by FIG. 1. The straps tightly extend around the bottom of table 212 and back to belt, thereby applying a downward force to the person (simulating gravity) to load platform 214.

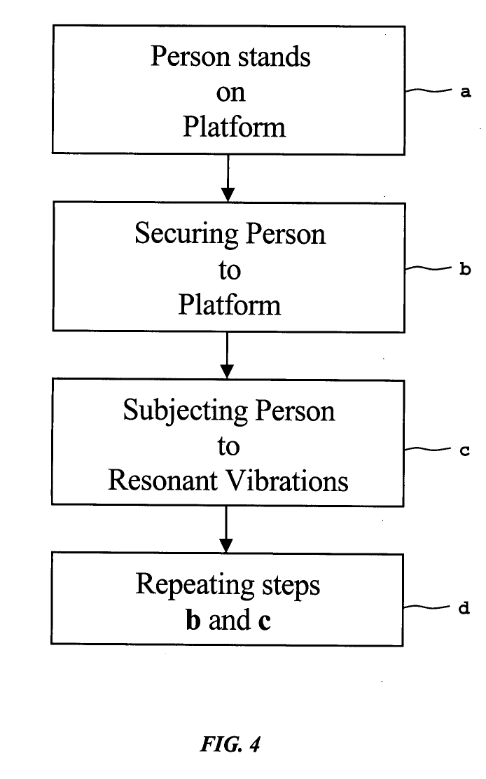

With reference to FIG. 4, the vibrational treatment method for performing dynamic motion therapy to a person in a weightless environment in accordance with the present disclosure includes the steps of (a) providing a vibration table having a non-rigidly supported platform; (b) securing the person to the non-rigidly supported platform; (c) subjecting the person to resonant vibrations generated by the non-rigidly supported platform; and (d) repeating steps (b) and (c) during a predetermined treatment duration. Step (b) includes securing the person to the platform using securing mechanisms provided on the platform and loading the platform using, for example, straps (such as elastic bungee cords) to apply a downward force to the person. Step (c) includes the step of subjecting the person to resonant vibrations having a frequency in the range of 1 Hz to 100 KHz, and preferably 1 Hz to 10 KHz. Typically, the resonant vibrations provide the vibrational stimulus at substantially the same frequency to the person.

It will be understood that various modifications may be made to the embodiments disclosed herein. Therefore, the above description should not be construed as limiting, but merely as exemplifications of the various embodiments. Those skilled in the art will envision other modifications within the scope and spirit of the claims appended hereto.

What is claimed is:

1. A non-invasive method for performing dynamic motion therapy of a person in a weightless environment, said method comprising the steps of:
(a) providing a vibration table having a non-rigidly supported platform;
(b) securing the person to the non-rigidly supported platform;
(c) subjecting the person to resonant vibrations generated by the non-rigidly supported platform; and
(d) repeating steps (b) and (c) during a predetermined treatment duration.

2. The method as recited in claim 1, wherein step (b) comprises the steps of:
providing a chamber having the non-rigidly supported platform as a base; and
allowing the person to enter the chamber and step onto the base.

3. The method as recited in claim 1, wherein step (b) comprises the steps of:
providing a locking mechanism to a top planar surface of the non-rigidly supported platform; and
locking a person's footwear to the non-rigidly supported platform via the locking mechanism.

4. The method as recited in claim 1, wherein step (b) comprises the step of applying a downward force to the person.

5. The method as recited in claim 1, wherein the resonant vibrations have a frequency in the range of 1 Hz to 100 KHz

6. The method as recited in claim 1, wherein the resonant vibrations have a frequency in the range of 1 Hz to 10 KHz.

7. The method as recited in claim 1, wherein step (c) is performed for a predetermined period of time.

8. The method as recited in claim 7, wherein the predetermined period of time is approximately 10 minutes during a 24-hour period.

9. The method as recited in claim 1, wherein the predetermined treatment duration is at least the duration of the weightless environment.

10. A non-invasive apparatus for dynamic motion therapy in a weightless environment comprising:
a vibration table having a non-rigidly supported platform for generating resonant vibrations; and
means for securing a person to the non-rigidly supported platform.

11. The non-invasive apparatus as recited in claim 10, wherein the means for securing comprises a chamber having the non-rigidly supported platform as a base.

12. The non-invasive apparatus as recited in claim 10, wherein the means for securing comprises a locking mechanism provided on a top planar surface of the non-rigidly supported platform, wherein the locking mechanism includes means for locking footwear to the non-rigidly supported platform.

13. The non-invasive apparatus as recited in claim 10, wherein the means for securing comprises a belt-strap combination.

14. The non-invasive apparatus as recited in claim 10, wherein the resonant vibrations have a frequency in the range of 1 Hz to 100 KHz

15. The non-invasive apparatus as recited in claim 10, wherein the resonant vibrations have a frequency in the range of 1 Hz to 10 KHz.

16. The non-invasive apparatus as recited in claim 10, wherein the resonant vibrations have a frequency of 30 Hz.

17. A non-invasive apparatus for dynamic motion therapy in a weightless environment comprising:
a vibration table having a non-rigidly supported platform for generating resonant vibrations;
means for securing a person to the non-rigidly supported platform; and
a chamber at least partially enclosing the non-rigidly supported platform and defining an interior compartment having the non-rigidly supported platform as a base.

18. The non-invasive apparatus as recited in claim 15, wherein the resonant vibrations have a frequency in the range of 1 Hz to 100 KHz

19. The non-invasive apparatus as recited in claim 15, wherein the resonant vibrations have a frequency in the range of 1 Hz to 10 KHz.

20. The non-invasive apparatus as recited in claim 15, wherein the resonant vibrations have a frequency of 30 Hz.
